(19) United States
(12) Patent Application Publication
(10) Pub. No.: US 2005/0198121 A1
(43) Pub. Date: Sep. 8, 2005

(54) Vertical enterprise system

(76) Inventors: Robert W. Daniels, Minneapolis, MN (US); Clifford Audinet, Highlands Ranch, CO (US)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 11/031,358

(22) Filed: Jan. 7, 2005

Related U.S. Application Data
(60) Provisional application No. 60/535,133, filed on Jan. 7, 2004.

(51) Int. Cl. G06F 15/16

(52) U.S. Cl. 709/203

(57) ABSTRACT

Vertical enterprise systems and methods for integrating applications from one or more enterprises into a single interface for presentation to a user are disclosed. A vertical enterprise system in accordance with an illustrative embodiment of the present invention may include one or more client enterprises, one or more partner enterprises, and an active integration enterprise in communication with the one or more client and partner enterprises. The active integration enterprise may include a central integration platform operating on an application integration network adapted to host a number of core components including a portal system, a collaboration system, a database system, and/or a business system. In certain embodiments, the active integration enterprise can be configured to host a number of user-specific applications that provide specific functionality for a particular client. In use, the active integration enterprise can be configured to permit the one or more client and/or partner enterprises to be utilized in a distributed fashion. A single sign-on interface of the portal system can provide the user with application data from multiple enterprises as a single view.

### CROSS REFERENCE TO RELATED APPLICATION

The present application claims benefit to provisional U.S. Patent Application Ser. No. 60/535,133, filed on Jan. 7, 2004.

### FIELD

The present invention relates generally to the field of business and data integration systems and methods. More specifically, the present invention pertains to vertical enterprise systems and methods for integrating applications from one or more enterprises into a single interface for presentation to a user.

### BACKGROUND

Business and data integration systems are becoming increasingly popular in Business-to-Business (B2B) and E-commerce applications for integrating multiple networks (i.e. enterprises) together in a common scheme. In the automotive dealership industry segment, for example, such systems have been employed to integrate networks used in tracking customer orders, managing vendor and/or supplier inventory requirements, automating sales leads as well as coordinating other related functions.

Integration among the various client enterprises poses a significant obstacle in many conventional business and data integration systems, preventing applications within a single enterprise or across multiple enterprises from effectively communicating with each other. Typically, a single enterprise model is employed wherein the functionality needed to manage and run business operations is handled by a central, monolithic application using point-to-point methodologies and batch processes, or a mix of point-to-point methodologies and message oriented middleware (MOM). In some systems, for example, integration is implemented as a batch process using standards such as electronic data interchange (EDI) or file transfer protocol (FTP), which require batch programs to be written in order to transfer data from an inbound file to another application. As a result, data is not easily reused or shared among applications. In some cases, separate interfaces and end-points must be created for each separate business transaction and/or each new application added to the system.

The ability to flexibly integrate new components into the system and to easily scale the system to work for a particular market segment is advantageous in many situations for client enterprises to properly leverage their business. Such flexibility and scalability is particularly desired in the small and medium business (SMB) market segments, where businesses typically have little or no IT resources available, or where individuals performing such IT functions may not have a deep understanding of the hardware, software, network, or application support necessary to effectively manage their IT technology. In some cases, the lack of flexibility and scalability in the IT infrastructure may prevent a particular business from effectively growing or changing its business strategy to better serve its customers. In certain industries such as the automotive dealership industry, for example, the use of outdated or proprietary IT infrastructure can adversely affect a dealer's bottom line, making it more difficult to effectively compete against competitors.

### SUMMARY

The present invention relates generally to vertical enterprise systems and methods for integrating applications from one or more enterprises into a single interface for presentation to a user. A vertical enterprise system in accordance with an illustrative embodiment of the present invention may include one or more client enterprises, one or more partner enterprises, and a web-based active integration enterprise in communication with the one or more client and partner enterprises. The active integration enterprise may include a central integration platform operating on an application integration network (AIN) adapted to host a number of core components including a portal system, a collaboration system, a database system, and/or a business system. The application integration network may include transport means such as the Internet or an intranet connection, and can include an integration middleware component with client side capability to facilitate integration with each enterprise within the system, allowing the system to function in a distributed fashion as a single solution to the user. In use, the active integration enterprise allows a user to access multiple applications within a single enterprise and/or across multiple enterprises using a single sign-on interface. Data obtained from one or more of the client and/or partner enterprises as well as those components hosted by the active integration enterprise can thus be provided to the user as a single view using a web-browser, graphical user interface (GUI), and/or other suitable interface.

In certain embodiments, the active integration enterprise can be further configured to host a number of user-specific applications that provide specific functionality for a particular client or partner enterprise. In an illustrative automotive dealership management system, for example, the active integration enterprise can be configured to host a custom business development center (BDC) application module and/or a parts and service application module that can be used to provide additional functionality to a dealership's existing applications without requiring additional expenditure of hardware or software infrastructure at the dealership level. In some embodiments, the user-specific applications as well as other core components hosted by the active integration enterprise can be web-based applications, allowing the user access information in real-time and from any location using a personal computer equipped with a web browser or other suitable interface. Because the user-specific applications and other hosted components can be built from the ground up using best-of-breed, web, and Internet technologies, the vertical enterprise system can be easily scaled to accommodate growth in the system. Furthermore, since all of the applications communicating with each other use the same integration platform, vertical-specific third-party applications can be easily integrated with the user-specific applications, thus providing greater flexibility for system upgrades and/or modifications.

An illustrative method of integrating applications from one or more client enterprises into a single interface for presentation to a user may include the steps of providing a central integration platform in communication with one or more client enterprises, the integration platform including an application integration network adapted to host a portal system, a collaboration system, a database system, and/or a business system; hosting one or more user-specific applications on the integration platform; providing a single sign-on interface for the user; and presenting data from the one or more user-specific applications and/or one or more existing applications as a single view to the user.

### BRIEF DESCRIPTION OF THE DRAWINGS

FIG. 1 is a schematic view of an illustrative vertical enterprise system in accordance with an exemplary embodiment of the present invention;

FIG. 2 is a schematic view of an illustrative vertical enterprise system in accordance with another exemplary embodiment of the present invention;

FIG. 3 is a schematic view showing illustrative hardware infrastructure for use with the integration platform of FIG. 2;

FIG. 4 is a schematic view of an illustrative J2EE platform for use with the integration platform of FIG. 2;

FIG. 5 is a schematic view showing the movement of data between applications using an illustrative XML scheme;

FIG. 6 is a schematic view of an illustrative collaboration system in accordance with an exemplary embodiment of the present invention;

FIG. 7 is a schematic view of an illustrative database system in accordance with an exemplary embodiment of the present invention;

FIG. 8 is a schematic view of an illustrative vertical enterprise system in accordance with another exemplary embodiment of the present invention;

FIG. 9 is a schematic view of an illustrative portal system for use with the vertical enterprise system of FIG. 8;

FIG. 10 is a schematic view of an illustrative business system for use with the vertical enterprise system of FIG. 8;

FIG. 11 is a schematic view showing illustrative hardware infrastructure for the business system of FIG. 10;

FIG. 12 is a schematic view of an illustrative vertical specific solution using the illustrative vertical enterprise system of FIG. 8;

FIG. 13 is a schematic view of an illustrative automotive dealership management system in accordance with an exemplary embodiment of the present invention;

FIG. 14 is a schematic view showing the flow of data through an illustrative automotive dealership management system;

FIG. 15 is a schematic view of an illustrative educational management system in accordance with an exemplary embodiment of the present invention;

FIG. 16 is a schematic view of an illustrative portal system for use with the educational management system of FIG. 15;

FIG. 17 is a schematic view of the student-management side of the illustrative educational management system of FIG. 15;

FIG. 18 is a schematic view of the business-management side of the illustrative educational management system of FIG. 15;

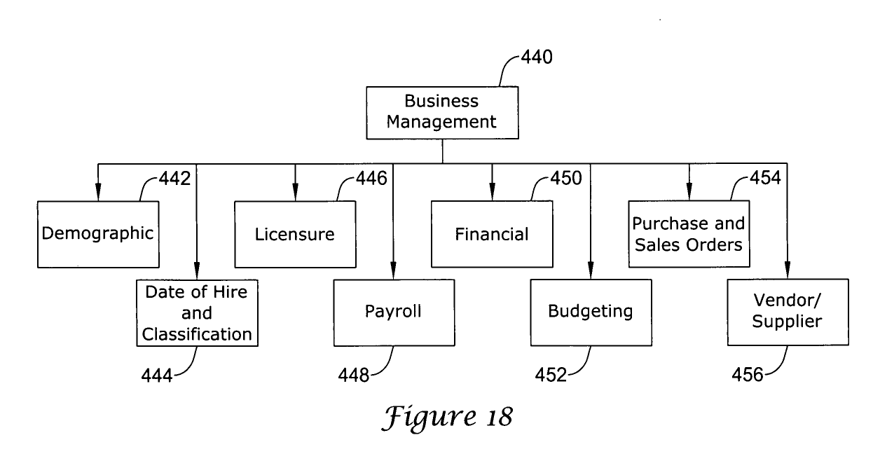

FIG. 19 is a schematic view of an illustrative educational solution using the illustrative educational management system of FIG. 15; and

FIG. 20 is a schematic view showing the flow of data through an illustrative educational management enterprise.

### DETAILED DESCRIPTION

The following description should be read with reference to the drawings, in which like elements in different drawings are numbered in like fashion. The drawings depict selected embodiments, and are not intended to limit the scope of the invention. Although examples of various systems and methods are illustrated in the various views, those skilled in the art will recognize that many of the examples provided have suitable alternatives that can be utilized.

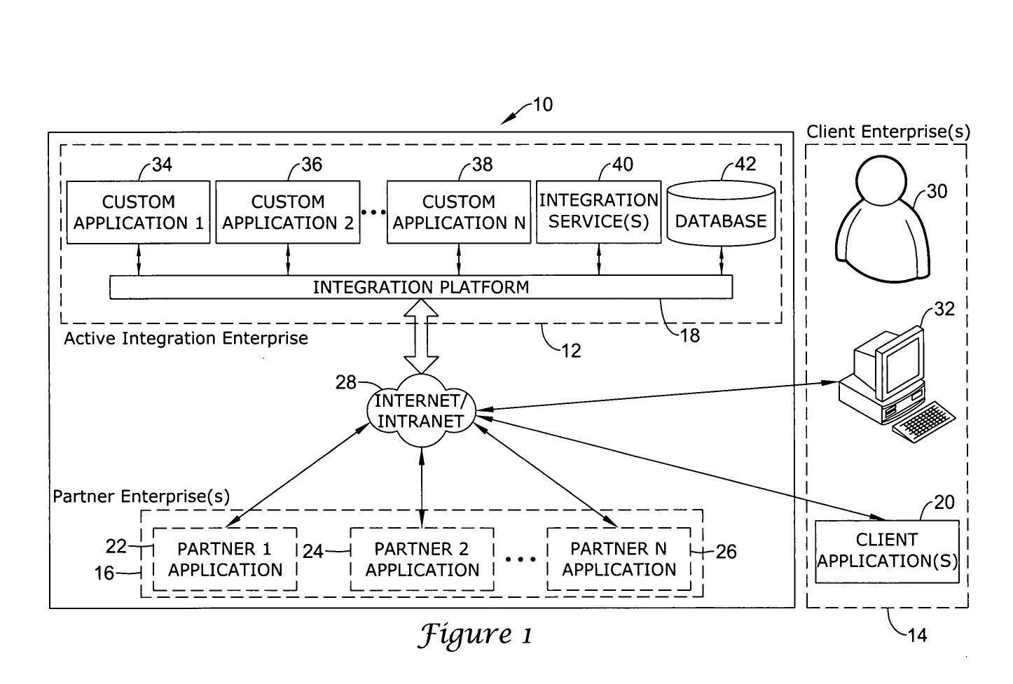

FIG. 1 is a schematic view of an illustrative vertical enterprise system in accordance with an exemplary embodiment of the present invention. The vertical enterprise system, represented generally by reference number 10 in FIG. 1, may comprise an application and technology framework, which, as described in greater detail below, provides the ability to create vertical user-specific business and data integration solutions by combining multiple applications from different geographic locations and/or different business entities into a single interface for presentation to a user. The vertical enterprise system 10 can be implemented in a particular market or industry segment to permit active integration of various client applications, allowing a user to access a variety of functionality from disparate sources using a single application workspace such as a personal computer equipped with a web-browser, graphical user interface (GUI), and/or other suitable interface.

In some embodiments, the vertical enterprise system 10 may provide the ability to offer hosted business and integration solutions by vertical (i.e. industry), allowing clients to offload all or a portion of their IT operations. Vertical industries that may benefit from such active integration may include, for example, the automotive, educational, banking, financial, retail, telecommunications, medical, semiconductor, legal, and/or other market segment in which it may be desirable to offload application functionality typically performed at the third-party level using propriety or public IT infrastructure.

The vertical enterprise system 10 may include a web-based active integration enterprise 12 in communication with a number of client enterprises 14 and partner enterprises 16. As indicated generally by dashed lines, the active integration enterprise 12 may include a central integration platform 18 that can be used to integrate one or more existing client applications 20 and/or partner applications 22,24,26 together via the Internet or an intranet connection 28, and then provide a single business solution as a single view to a user 30 via a personal computer 32 equipped with a web-browser, graphical user interface (GUI), and/or other suitable interface.

The active integration enterprise 12 can be configured to operate on an application integration network (AIN) that provides the various network and integration topology necessary to integrate the various client and partner applications 20,22,24,26 as well as host one or more user-specific (i.e. custom) applications 34,36,38. In certain embodiments, for example, the user-specific applications 34,36,38 may comprise vertical specific applications adapted to provide various functionality (e.g. inventory management, order tracking, repair scheduling, etc.) to a particular client or partner enterprise 14,16 from the ground up. The user-specific applications 34,36,38 may also comprise existing client and/or partner applications as well as other third-party applications (e.g. an application from a vendor or supplier). In use, the application integration network (AIN) provides a network and integration infrastructure that allows the one or more client and partner enterprise applications 20,22,24,26 as well as the hosted applications 34,36,38 to be utilized together in a distributed fashion.

A number of integration services 40 hosted by the active integration enterprise 12 can be configured to provide core functionality for the active integration enterprise 12. In certain embodiments, for example, the integration services 40 may include the transport and middleware infrastructure (e.g. web servers, application servers, development servers, routers, switches, software applications, application connectors, etc.) to permit the various applications 20,22,24,26 to communicate with each other. Other core components such as a business system software suite adapted to handle various business tasks (e.g. accounting, payroll, inventory management, etc.) may also be hosted by the active integration enterprise 12, if desired.

A database 42 hosted by the active integration enterprise 12 can be configured to provide storage for each application within the vertical enterprise system 10 as well as user data such as login names, passwords, email account information, etc. The database 42 can be configured to provide each client, application, and market vertical within the vertical enterprise system 10 with access to only its data and any user-specific applications 34,36,38 and integration service(s) 40 associated with that client, application, or market vertical. Unlike an exchange where members usually have access to common data stores that are aggregated by industry, the database 42 can be configured to prevent the user from accessing other client's data or applications except as required by the client's own integration needs and specific business partnerships.

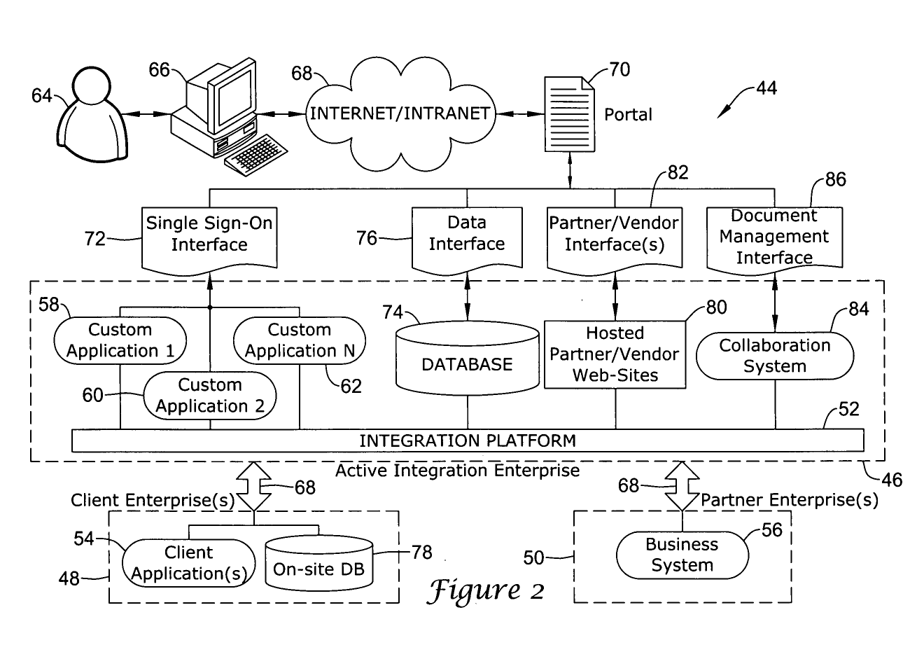

Referring now to FIG. 2, a schematic view of an illustrative vertical enterprise system 44 in accordance with another exemplary embodiment of the present invention will now be described. As shown in FIG. 2, the illustrative vertical enterprise system 44 may include a web-based active integration enterprise 46 in communication with a number of client enterprises 48 and partner enterprises 50. The active integration enterprise may include a central integration platform 52, which in the illustrative embodiment, can be used to permit one or more existing client applications 54, one or more partner applications 56 (e.g. a business system), and one or more user-specific applications 58,60,62 to be utilized in a distributed fashion and presented as a single view to a user 64 via a personal computer 66 equipped with a web-browser, graphical user interface (GUI), and/or other suitable interface. In some embodiments, the user 64 as well as the one or more client and partner enterprises 48,50 can be connected to the active integration enterprise 46 via the Internet or an intranet connection 68, allowing the user 64 to access the various applications and associated data in real-time and from any location.

The integration platform 52 can be configured to operate on an application integration network (AIN) that provides the transport layer infrastructure for integrating the various applications and associated data together, and for providing such data to the user 64. The integration platform 52 may be based on a bus architecture similar to that commonly provided on a computer. The bus architecture may support both queuing and publish/subscribe implementations, and may allow end-points to exist within a single enterprise or across multiple enterprises. In the illustrative embodiment of FIG. 2, the transport infrastructure is shown implemented via the Internet and/or an intranet connection (e.g. via a LAN, WLAN, etc.). It should be understood, however, that the application integration network could be configured to operate on other suitable transport mechanisms such as a wireless or satellite connection, if desired.

In addition to hosting the transport layer infrastructure, the active integration enterprise 46 can be further configured to host an integration middleware component having client side capability. The integration middleware component provides various application and data connectivity and data transformation and routing services, allowing each enterprise within the vertical enterprise system 44 to be connected together. In contrast to many convention systems, the integration middleware component can be hosted directly by the active integration enterprise 46, and is thus not a separate vertical within the vertical enterprise system 44.

As can be further seen in FIG. 2, the active integration enterprise 46 can host a number of core components that can be utilized to create business or data solutions for a given market segment (e.g. the automobile dealership industry) and its clients. The active integration enterprise 46 may include a portal 70 that can be configured to manage content received from the integrated applications and present such data as a single view or solution to the user 64 via a single sign-on interface 72. The portal 70 may comprise a number of software and/or hardware applications that coordinate the various disparate applications (i.e. custom applications, legacy applications, etc.) together in one place, thereby providing a single, uniform interface for the user 64. In addition, the portal 70 may also provide built-in administrative functionality for managing the various components hosted by the active integration enterprise 46. In some embodiments, the single sign-on interface 72 may include a graphical user interface (GUI) that can be accessed by the user 64 and/or an administrator via the Internet and/or intranet connection 68. Other means for connecting and interfacing with the portal 70 may be provided, however, depending on the application.

The active integration enterprise can further host a database 74 that provides storage for each application within the vertical enterprise system 44 as well as user access data. As with other embodiments herein, the database 74 can be configured to provide each client, application, and market vertical within the vertical enterprise system 44 with access to only its data and any user-specific applications 58,60,62 and any integration service(s) associated with that client, application, or market vertical. The database 74 contents may be made available via a data interface or portlet 76, allowing the user 64 to view data contained within the database 74 via the Internet or intranet connection 68.

The database 74 can be configured such that each client, application, and/or market vertical has access to only its data, providing a level of security for other hosted clients. In certain embodiments, for example, the database 74 may be responsible for the data storage needs of a particular client, application and/or market vertical using a Relational Database Management System (RDMS) that operates on a normalized schema. Using such system, data can be stored and accessed by both applications and users of the system for business and reporting needs, as necessary, and can be segmented by client such that only data associated with a particular client can be accessed by that client. If desired, an on-site database 78 can be provided at the client enterprise level to ensure that operations continue in the event that a communication outage or network bottleneck occurs.

The active integration enterprise 44 can be further configured to host a number of partner and/or vendor web sites 80 that can be further presented to the user 64 via a partner/vendor interface or portlet 82. The partner/vendor interface 82 can be configured to provide a means for the user 64 to directly or indirectly interact with one or more of the client and/or partner enterprises 48,50 or other third-party clients, as desired. In certain embodiments, the partner/vendor interface 82 can be accessed from the single sign-on interface 72, allowing information from multiple enterprises to be presented to the user as a single view. Alternatively, and in other embodiments, the partner/vendor interface 82 can be provided as a separate interface from the sign-on interface 72, if desired.

The active integration enterprise 44 can be further configured to host a collaboration system 84 that provides various document management functions for the vertical enterprise system 44. The collaboration system 84 may include a document management application that provides workflow functionality to tailored users, or groups of users, and that permits integration with other document management systems, if desired. In some embodiments, the document management system can be tailored to a specific vertical (e.g. client enterprise 54). The document management system can be accessed via a document management interface or portlet 86, which permits each user 64 of the vertical enterprise system 44 to check documents in and out of a central repository, archive documents, and/or back-up documents, as desired. Other functions such as email support, calendaring, scheduling, security, version control, and/or administrative functionality can be further accessed via the document management interface 86, if desired.

The user-specific applications 58,60,62 hosted by the active integration enterprise 46 can be configured to provide custom functionality for one or more client and/or partner enterprises 48,50. The user-specific applications 58,60,62 may supplement applications currently existing at the client or enterprise level, or may provide for application functionality from the ground up. In some embodiments, for example, the user-specific applications 58,60,62 may provide for application functionality that is not already included within one of the enterprises 48,50, but which may be required in providing a specific business solution to a user. In the context of the automotive dealership industry, for example, the user-specific applications 58,60,62 may include a custom coded software application that can be utilized by automotive dealers to track inventory and manage business contacts. Other applications are possible, however.

By providing a technology framework that aggregates user-specific applications 58,60,62 as well as various common business components 56,74,80,84 together using a central integration platform 52, the client and/or partner enterprises 48,50 can each offload all or a portion of their IT operations, reducing the hardware, maintenance, and upgrade costs normally associated with hosting such components at the client or partner enterprise level. Moreover, because the user-specific applications 58,60,62 and other hosted components 74,80,84 can be built from the ground up using best-of-breed, web, and Internet technologies, the vertical enterprise system 44 can be easily scaled to accommodate growth in the system. Furthermore, since all of the applications communicating with each other use the same integration platform 52, vertical-specific third-party applications can be easily integrated with the user-specific applications 58,60,62, enabling more flexibility than with proprietary solutions. The addition of a new application or enterprise to the vertical enterprise system 44 requires adding only one end-point to the integration infrastructure, thereby reducing the number of application connectors necessary to connect the various applications and enterprises together.

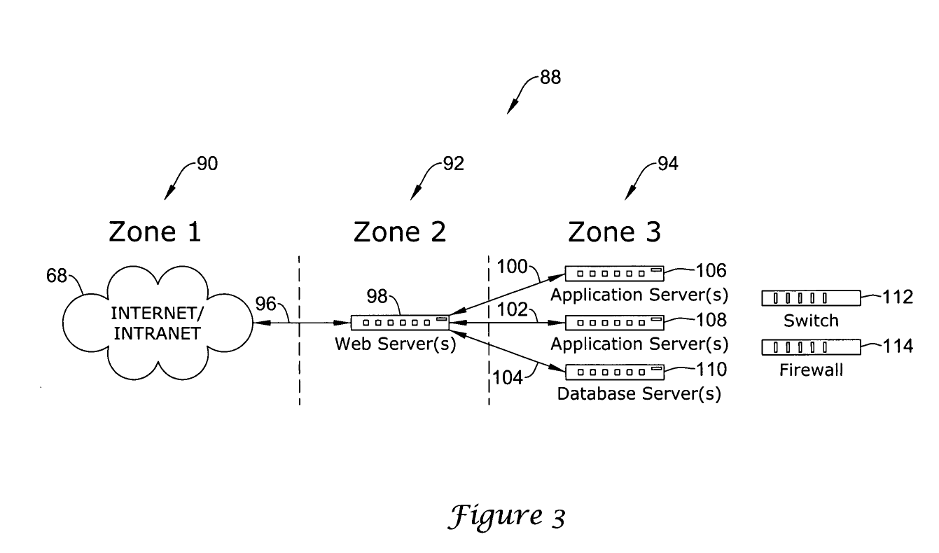

FIG. 3 is a schematic view showing illustrative hardware infrastructure 88 for use with the integration platform 52 of FIG. 2. As shown in FIG. 3, the hardware infrastructure 88 can be configured to operate over a series of zones 90,92,94, each zone representing a different layer of the hardware infrastructure 88. As indicated generally by arrow 96, an Internet/intranet connection 68 in a first zone 90 can be connected to one or more web servers 98 in a second zone 92 that provide a portal for the user 64 to access various application components, as described above. As indicated generally by arrows 100,102, and 104, the web servers 98 can be further connected to a number of application servers 106,108 and a database server 110 in a third zone 94. A switch 112 can be provided to route operations to the appropriate application server 106,108 and to the database server 110, as needed. A firewall 114 can also be provided to ensure privacy between the Internet/intranet connection 68 and each of the web, application and database servers 98,106,108.

The hardware infrastructure 88 can be architected to allow scalability and segmentation for each hosted application without affecting the Internet/intranet connection 68 or the web servers 98. Each hosted application within the vertical enterprise system 44 may have its own individual application server, which can be grouped according to its own vertical function. Moreover, each server 106,108,110 as well as each hosted application within the active integration enterprise 46 can be replicated for flexibility and scalability purposes.

The software infrastructure necessary to operate the web server 98 may include any number of suitable software platforms known in the art. In certain embodiments, for example, the software infrastructure may be based on the Java 2, Enterprise Edition (J2EE) platform, which provides a standard for developing multi-tier enterprise applications by basing them on standardized, modular components, by providing a complete set of services to those components, and by handling various details relating to each application's behavior.

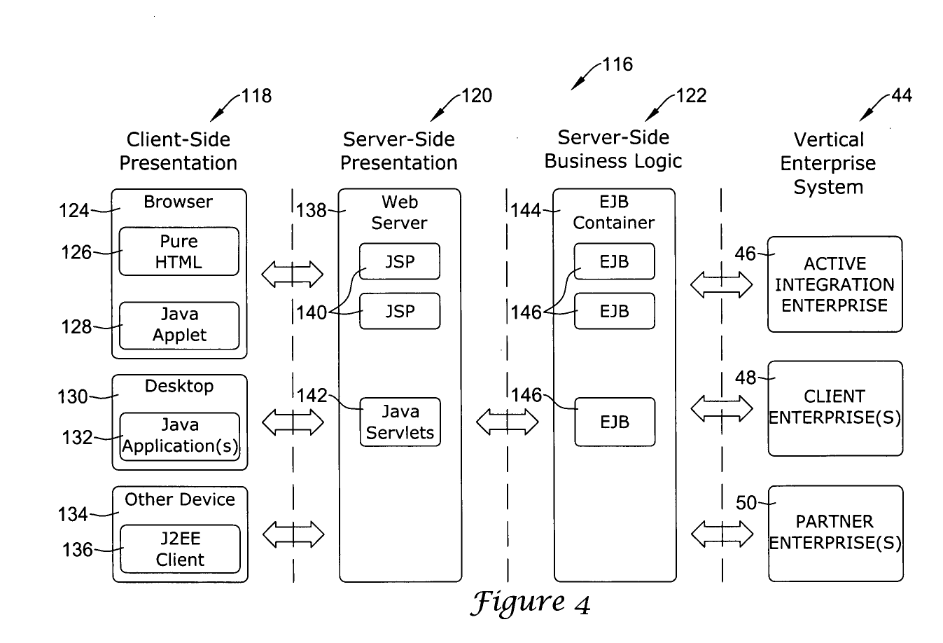

FIG. 4 is a schematic view of an illustrative J2EE platform 116 for use with the integration platform 52 of FIG. 2. As can be seen in FIG. 4, the J2EE platform 116 may include client-side presentation means 118, server-side presentation means 120, and various server-side business logic 122 that can be interfaced with the active integration enterprise 46 and one or more client and/or partner enterprises 48,50 of the vertical enterprise system 44.

The client-side presentation means 118 can be configured to present information to a user via a web-browser 124 adapted to run client-side interfaces using pure HTML 126, Java applets 128, or other suitable standard. A desktop interface 130 adapted to run one or more Java applications 132 or other desired application can be further provided as a part of the client-side presentation means 118, if desired. In some embodiments, other devices can be further integrated into the J2EE platform 116 for connection to other J2EE clients 136 such as a PDA or laptop.

The server-side presentation means 120, in turn, can be configured to run on a web-server 138 or other suitable platform. For server-side generation of dynamic content, the J2EE platform 116 can be configured to support web components such as Java Server Pages (JSP) 140 or Java Servlets 142 using a suitable integration scheme such as XML. In an XML scheme, data related to a given business transaction (e.g. a sales order transaction) can be moved between the various applications in an XML document using XSL transforms.

The server-side business logic portion 122 of the J2EE platform 116 can include an Enterprise Java Bean container 144 adapted to run a model such as Enterprise JavaBeans (EJB) 146, which enables a simplified approach to multi-tier application development. For server-side generation of dynamic content, the J2EE platform 116 can be configured to support web components such as Java Server Pages (JSP) or Java Servlets using a suitable integration scheme such as XML.

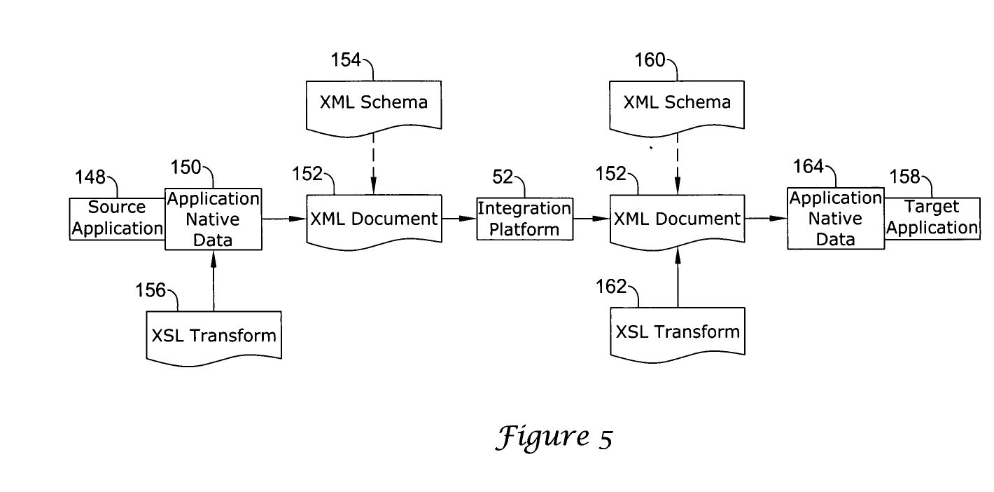

FIG. 5 is a schematic view showing the movement of data between applications using an illustrative XML scheme. As can be seen in FIG. 5, a source application 148 including application native data 150 is transformed from its native form into an XML document 152 using a first XML schema 154 and a first XSL transform 156. Once converted into an XML format, the XML document 152 is then passed across the integration platform 52 to a target application 158 using a second XML schema 160 and a second XSL transform 162 that transforms the XML document 152 into application native data 164 for use by the target application 158.

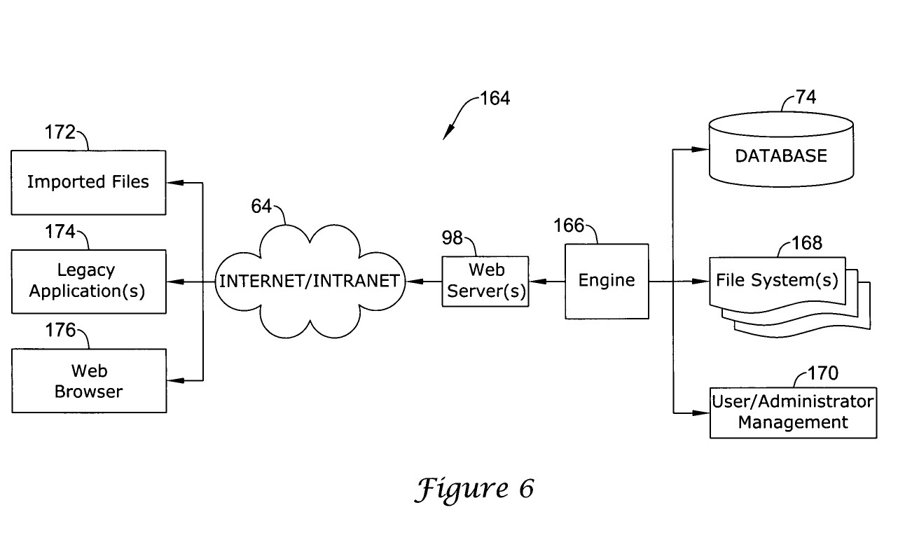

FIG. 6 is a schematic view of an illustrative collaboration system 164 in accordance with an exemplary embodiment of the present invention. As shown in FIG. 6, the collaboration system 164 may include an engine 166 that can be used to perform various tasks related to document management, including performing database functions (e.g. archiving, back-up, etc.) on the database 74, collaborating one or more file systems 168 as well as provide various user and/or administrator management functions 170. Other examples of functions performed by the engine 166 may include, but are not limited to, document check-in and check-out, file locking, security, and/or version control.

The collaboration system 164 can be configured to further interact with a number of other applications and/or components via the Internet/intranet connection 68 and the web servers 98. The engine 164 can be configured to facilitate collaboration of imported files 172 from a scanner or other plug-n-play device as well as data from one or more legacy applications 174. Data provided by users via a web browser 176 or other interface can be further collaborated using the engine 164, if desired.

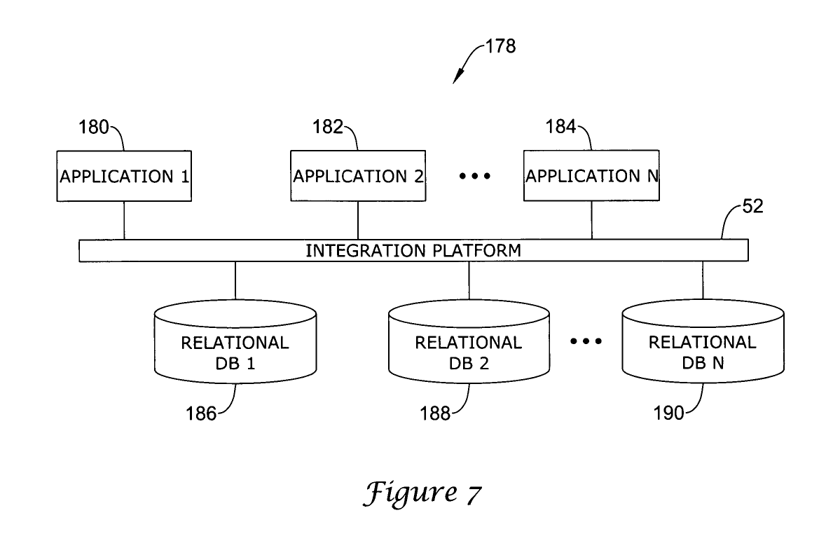

FIG. 7 is a schematic view of an illustrative database system 178 in accordance with an exemplary embodiment of the present invention. The database system 178, illustratively a core data and relational database management system, may include a number of vertical enterprise system applications 180,182,184 each connected to a corresponding relational database 186,188,190 via the integration platform 52. Each relational database 186,188,190 can be configured to permit only those applications 180,182,184 having permission to gain access to data contained therein. While separate relational databases 186,188,190 are depicted in the illustrative embodiment of FIG. 7, it should be understood that the relational databases 186,188,190 can be provided as a single database (e.g. on a single database server), with each database 186,188,190 being segmented or partitioned by corresponding application 180,182,184. In certain embodiments, the database system 178 may comprise a web-based system, allowing users to gain access to the database contents in real-time and from any location via the integration platform 52.

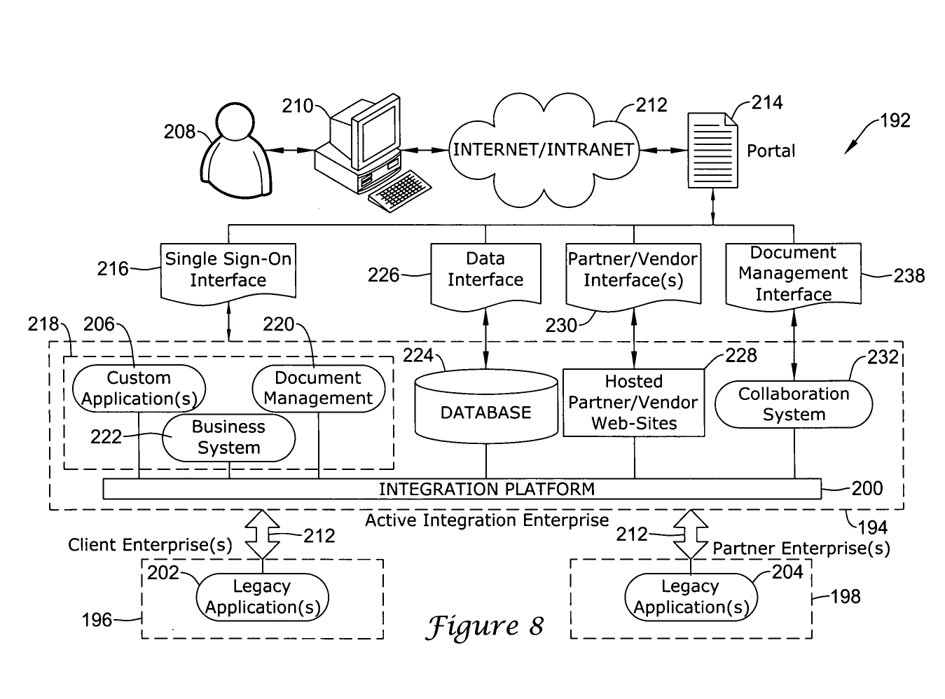

FIG. 8 is a schematic view of an illustrative vertical enterprise system 192 in accordance with another exemplary embodiment of the present invention. As shown in FIG. 8, the illustrative vertical enterprise system 192 may include a web-based active integration enterprise 194 in communication with a number of client enterprises 196 and partner enterprises 198, similar to that described above with respect to FIG. 2. The active integration enterprise 194 may include a central integration platform 200, which in the illustrative embodiment, can be used to permit one or more client legacy applications 202, one or more partner legacy applications 204, and one or more user-specific applications 206 to be utilized in a distributed fashion and presented as a single view to a user 208 via a personal computer 210 equipped with a web-browser, graphical user interface (GUI), and/or other suitable interface. As with other embodiments herein, the user 208 as well as the one or more client and partner enterprises 196,198 can be connected to the active integration enterprise 194 via the Internet or an intranet connection 212, allowing the user 208 to access the various applications and associated data in real-time and from any location. In some embodiments, the integration platform 200 can be configured to operate on an application integration network (AIN) having a transport layer infrastructure and an integration middleware component with client side capability.

The active integration enterprise 194 can host a number of core components that can be utilized to create business or data solutions for a given market segment and its clients. As shown in FIG. 8, a portal 214 can be configured to manage content received from the integrated applications and present such data as a single view or solution to the user 208 via a single sign-on interface 216. As indicated by dashed lines 218, for example, the single sign-on interface 216 can be configured to provide the user 208 with a single view of several different applications, including the one or more user-specific applications 206, a document management system 220, and a business system 222. The single sign-on interface 216 can be configured to provide the user 208 a single view of the application data irrespective of whether the application is hosted by the active integration enterprise 194, by a client or partner enterprise 196,198, or by some other third-party client.

A database 224 accessible via a data interface or portlet 226 can be further hosted by the active integration enterprise 194 to provide data storage for each application within the vertical enterprise system 192. As with other embodiments herein, the database 224 can be configured to provide each client, application, and market vertical within the vertical enterprise system 192 with access to only its data and any user-specific applications 206 and integration service(s) associated with that client, application, or market vertical. In certain embodiments, for example, the database 224 may be responsible for the data storage needs of a particular client, application and/or market vertical using a Relational Database Management System (RDMS) that operates on a normalized schema.

The active integration enterprise 194 can be further configured to host a number of partner and/or vendor web sites 228 that can be further presented to the user 208 via a partner/vendor interface or portlet 230. The partner/vendor interface 230 can be configured to provide a means for the user 208 to directly or indirectly interact with one or more of the client and/or partner enterprises 196,198 or other third-party clients. Access to the hosted partner/vendor web sites 228 can be accomplished via the single sign-on interface 216, or through a separate interface from the sign-on interface 216, as desired.

A collaboration system 232 hosted by the active integration enterprise 194 can be configured to provide various document management functions for the vertical enterprise system 192. The collaboration system 232 may include a document management application that provides workflow functionality to tailored users, or groups of users, and that permits integration with other document management systems, if desired. In some embodiments, the document management system can be tailored to a specific vertical (e.g. client legacy application 202, partner legacy application 204, etc). The document management system can be accessed via a document management interface or portlet 238, which permits each user 208 of the vertical enterprise system 192 to check documents in and out of a central repository, archive documents, and/or back-up documents, as desired. Other functions such as email support, calendaring, scheduling, security, version control, and/or administrative functionality can be further accessed via the document management interface 238, if desired.

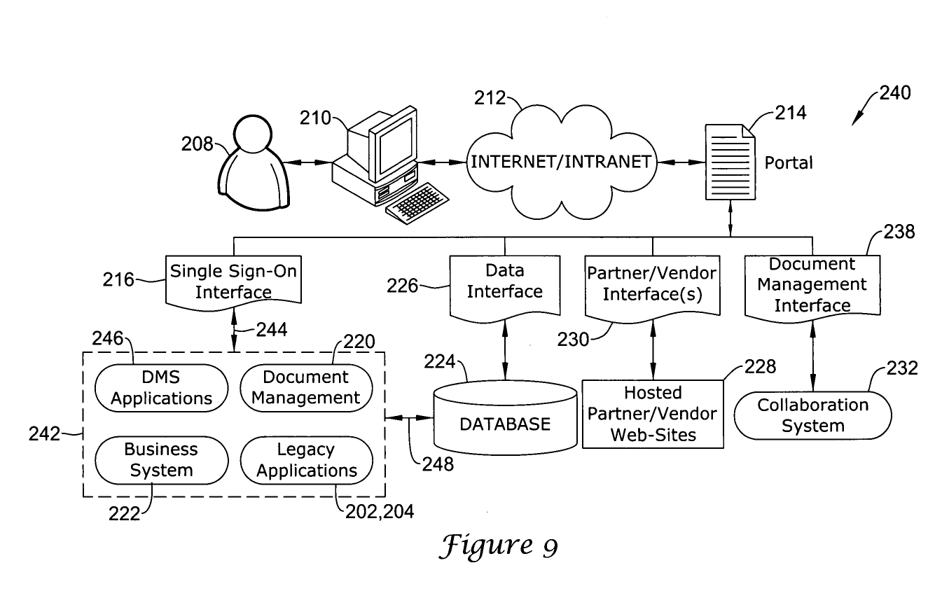

FIG. 9 is a schematic view of an illustrative portal system 240 for use with the vertical enterprise system 192 of FIG. 8. In the illustrative embodiment of FIG. 9, the portal system 240 can be configured to permit the user 208 to access one or more hosted and/or third-party applications via the single sign-on interface 216, which as is indicated generally by dashed lines 242 and arrow 244, can be presented as a single view to the user 208 via the single sign-on interface 216 of the portal 214. The applications may include, for example, one or more third-party document management system (DMS) applications 246, a hosted document management system (DMS) application 220, a business system application 222, and one or more legacy applications 202,204. In certain embodiments, multiple authentication schemes can be pooled together so that the user 208 does not have to remember a different login and password for each accessed application 220,222,202,204,246.

As is further indicated generally by arrow 248, each of the applications 220,222,202,204,246 accessible via the single sign-on interface 216 can be connected to the database 224, allowing for data storage across the vertical enterprise system 192. In some embodiments, the single sign-on interface 216 can also be configured to coordinate access to the other applications via the data interface 226, the partner/vendor interface(s) 230, and/or the document management interface 238.

The portal system 240 can be configured to permit administrators to manage users, groups, and roles through the portal 214 using a suitable interface such as a graphical user interface (GUI). A “group”, as used herein, is understood to mean a collection of users. “Roles”, in turn, signify permissions that a group of users are generally bound to. In the automotive dealership industry, for example, a “group” may comprise a number of automotive customers whereas a “role” may include a permission for each customer to access an order-tracking summary of their own account. In use, access to particular interfaces 216,226,230,238 within the portal system 240 can be restricted based on these roles.

By employing a portal 214 that integrates the various disparate applications of the vertical enterprise system 192 together in a common scheme, the portal system 240 may provide a single access point for users of the system vis-à-vis a single sign-on environment. In those embodiments employing a J2EE platform, for example, the portal system 240 may facilitate integration with other web-based and/or legacy applications, simplifying the development of secure J2EE applications by leveraging authentication, authorization, and/or provisioning functions. Moreover, by centralizing authorization and provisioning functions, the portal system 240 may reduce system cost and vulnerability over conventional ASP systems.

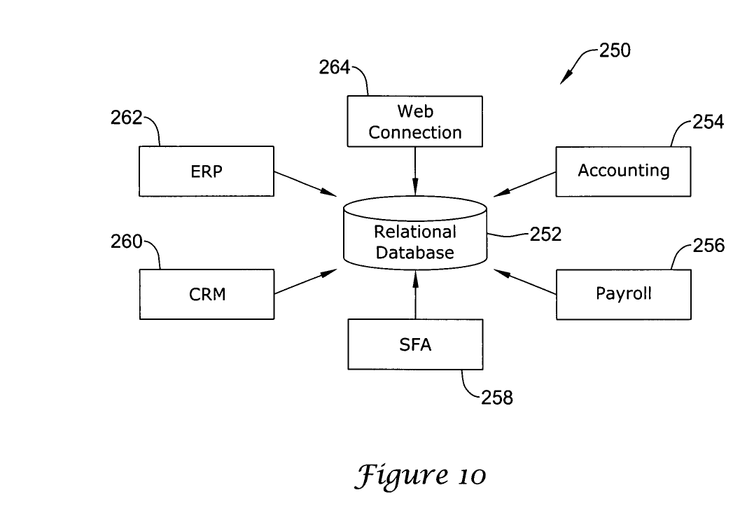

FIG. 10 is a schematic view of an illustrative business system 250 for use with the vertical enterprise system 192 of FIG. 8. As shown in FIG. 10, the business system 250 may employ a central relational database 252 interconnected with a number of business suite application modules that provide various front-door, back-door, and E-commerce functionality. In certain embodiments, for example, the business system 250 may employ a web-based application suite such as Net Ledger®, available as part of the Oracle® family of business solutions (e.g. Oracle 9i). It should be understood, however, that other business systems suites may be employed, if desired.

The relational database 252 can be connected to a number of modules including, for example, an accounting module 254, a payroll module 256, a sales force automation (SFA) module 258, a customer relationship management (CRM) module 260, and an enterprise resource planning (ERP) module 262. Each of the modules 254,256,258,260,262 can be linked to a web connection 264, allowing the user to gain access to one or more of the modules 254,256,258,260,262 via the Internet or an intranet connection. Other modules (e.g. a shipping module, a financing module, an inventory module, a purchasing module, etc.) may also be integrated with the relational database 252, as desired. The types of modules integrated into the business system 250 will typically vary depending on the particular application.

By providing core business functionality for the front-door and back-door of the business system 250, the business system modules 254,256,258,260,262 may provide a ubiquitous business solution that facilitates single data entry that extends across the entire vertical enterprise system 192. In addition, the business system 250 can be configured to eliminate redundant data entry and data management functions, reducing the cost and complexity of the vertical enterprise system 192. Moreover, because each integrated module 254,256,258,260,262 is accessible on-line via a web connection 264, the business system 250 can provide the user with real-time access anywhere, anytime, and through any device.

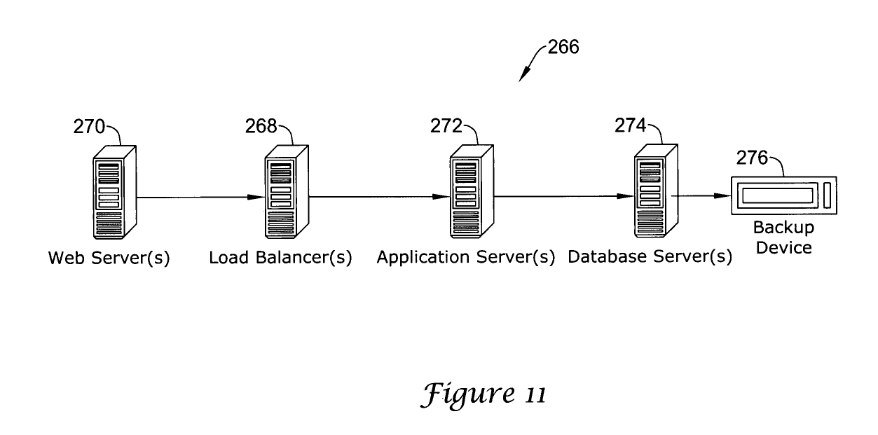

In certain embodiments, the ASP hosting infrastructure can be configured to provide a level of redundancy to the business system 250 to eliminate system failure due to one or more critical components failing in any system or subsystem, or as a result of a network bottleneck. In one illustrative embodiment depicted in FIG. 11, for example, the hosting infrastructure 266 may employ a number of load balancers 268 that can be connected between the web server(s) 270 and each application server 272 and database server 274 to reduce network bottlenecks and increase overall system performance. The load balancers 268 can be configured to reduce network bottlenecks by monitoring vital statistics related to availability and server load, and then dynamically direct traffic to the optimal application and/or database server 272,274. To prevent data loss failure, a backup device 276 such as tape backup, hard-drive, optical drive, or other suitable storage means can be tasked to periodically or continually backup data.

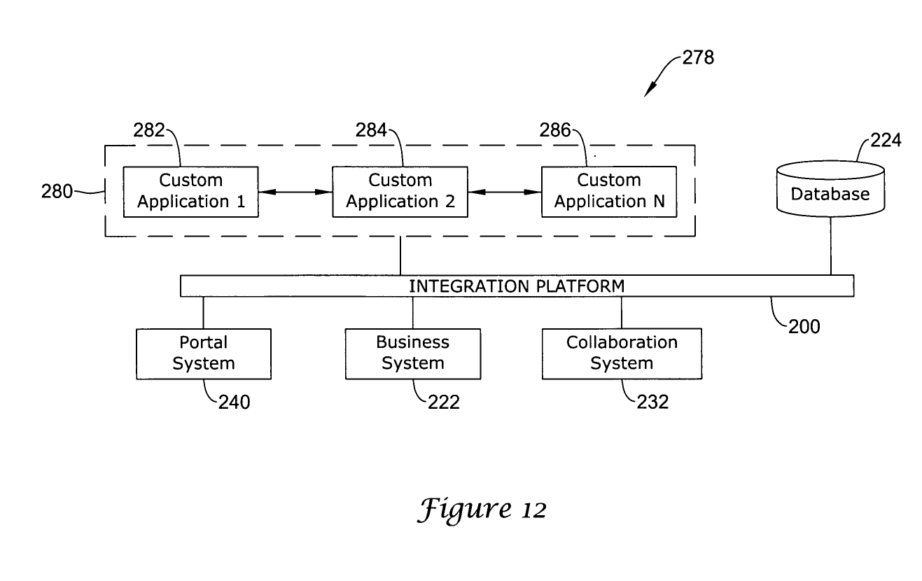

FIG. 12 is a schematic view of an illustrative vertical specific solution 278 using the illustrative vertical enterprise system 192 of FIG. 8. As indicated generally by dashed lines 280 in FIG. 12, the vertical specific solution 278 may include a number of user-specific (i.e. custom) applications 282,284,286 that can be integrated together and to other applications within the vertical enterprise system 192. In the context of an automotive dealership management system, for example, the user-specific applications 282,284,286 may comprise a business development center (BDC) application module, a parts and service application module, an inventory tracking application module, or other desired application module.

Each user-specific application 282,284,286 can be tasked to provide a specific vertical function, and can be modified or upgraded individually without affecting the operation of the other user-specific applications 282,284,286 or other applications within the vertical enterprise system 192. For example, the addition of a new user-specific application such as a customized inventory tracking application can be accomplished using a single end-point connection to the integration platform 200 without affecting the operation or connectivity of the other applications and/or system components connected thereto. In addition to providing flexibility to add, modify, and/or upgrade applications, the architecture of the vertical specific solution 278 may also provide other benefits such as a centralized data repository, scalability, real-time cross-organization data visibility, and data and application access anywhere, anytime and through any device.

During operation, the integration platform 200 can be responsible for moving data from each application across the application integration network, irrespective of whether the network operates via the Internet or an intranet connection. By providing a means for users and other applications within the vertical enterprise system 192 to access, transact, and share data across the network, the integration platform 200 provides a normalized data scheme that allows for more efficient data mining and searching capabilities, and that allows access to data in real-time. Moreover, by loosely coupling the applications to the integration platform 200, as described above, applications can be added, removed, and/or replaced without affecting the functionality of the existing components, thus providing flexibility and scalability to the system.

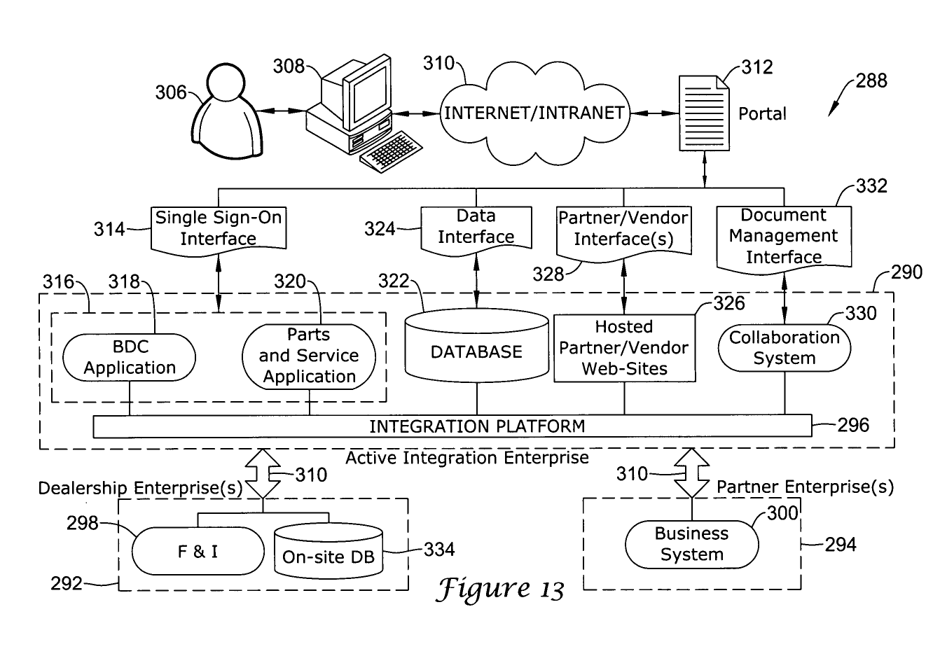

Referring now to FIG. 13, an illustrative automotive dealership management system (DMS) 288 in accordance with an exemplary embodiment of the present invention will now be described. As shown in FIG. 13, the illustrative automotive dealer management system 288 may include a web-based active integration enterprise 290 in communication with a number of dealership enterprises 292 and partner enterprises 294.

The active integration enterprise 290 may include a central integration platform 296, which as described above, can be used to allow one or more client applications 298 (e.g. an existing finance and insurance application), one or more partner applications (e.g. a business system 300), and one or more user-specific applications 302,304 to be utilized in a distributive fashion and presented as a single view to a user 306 via a personal computer 308 equipped with a web-browser, graphical user interface (GUI), and/or other suitable interface. As with other embodiments herein, the user 306 as well as the one or more client and partner enterprises 292,294 can be connected to the active integration enterprise 290 via the Internet or an intranet connection 310, allowing the user 306 to access the various applications and associated data in real-time and from any location. In some embodiments, the integration platform 296 can be configured to operate on an application integration network (AIN) that provides a transport layer infrastructure and an integration middleware component with client side capability.

The active integration enterprise 290 can host a number of core components that can be utilized to create specific business solutions for automotive dealerships and their clients. As shown in FIG. 13, a portal 312 can be configured to manage content received from the integrated applications and present such data as a single view or solution to the user 306 via a single sign-on interface 314. As indicated by dashed lines 316, for example, the single sign-on interface 314 can be configured to provide the user 306 with a single view of several applications, including a business development center (BDC) application 318 and a parts and service application 320. The single sign-on interface 314 can provide the user 306 with a single view of the application data irrespective of whether the application is hosted by the active integration enterprise 290, by a dealership or partner enterprise 292,294, or by some other third-party client.

A database 322 accessible via a data interface or portlet 324 can be further hosted by the active integration enterprise 290 to provide data storage for each application within the automotive dealership management system 288. As with other embodiments herein, the database 322 can be configured to provide each client, application, and market vertical within the system 288 with access to only its data and any user-specific (i.e. custom) applications 318,320 and integration service(s) associated with that client, application, or market vertical. In certain embodiments, for example, the database 322 may be responsible for the data storage needs of a particular automotive dealership and/or partner/vendor using a Relational Database Management System (RDMS) that operates on a normalized schema.

The active integration enterprise 290 can be further configured to host a number of partner and/or vendor web sites 326 that can be further presented to the user 306 via a partner/vendor interface or portlet 328. The partner/vendor interface 328 can be configured to provide a means for the user 306 to directly or indirectly interact with one or more of the dealership and/or partner enterprises 292,294 or other third-party clients. Access to the hosted partner/vendor web sites 326 can be accomplished via the single sign-on interface 314, or through a separate interface from the sign-on interface 314, as desired.

A collaboration system 330 hosted by the active integration enterprise 290 can be configured to provide various document management functions for the automotive dealership management system 288. The collaboration system 330 may include a document management application that provides workflow functionality to tailored users, or groups of users, and that permits integration with other document management systems, if desired. In some embodiments, the document management system can be tailored to a specific vertical (e.g. dealership application 298, partner business system 300, etc). The document management system can be accessed via a document management interface or portlet 332, which permits each user 306 of the automotive dealership management system 288 to check documents in and out of a central repository, archive documents, and/or back-up documents, as desired. Other functions such as email support, calendaring, scheduling, security, version control, and/or administrative functionality can be further accessed via the document management interface 332, if desired.

In the illustrative embodiment of FIG. 13, the hosted business development center (BDC) application 318 may comprise a web-based component that provides functionality for the customer sales process, or BDC sales flow. In certain embodiments, for example, the BDC application 318 can be configured to handle customer sales inquiries, quotations, order entry, order management, or other sales-related tasks throughout the sales process. In some embodiments, the BDC application 318 can be configured to supplement existing sales functionality at the dealership enterprise level. Alternatively, and in other embodiments, the BDC application 318 can be configured to provide functionality from the ground up in those situations where no existing application is present at the dealership enterprise level.

The hosted parts and service application 320 may similarly comprise a web-based component that provides functionality for the service-side of the automotive dealership management system 288. In certain embodiments, for example, the parts and service application 320 can be configured to perform functions related to inventory management, order tracking, repair scheduling, and/or other desired service-related function. As with the BDC application 318, the parts and service application 320 can be configured to supplement existing applications already contained at the dealership enterprise level, or can be used to provide such functionality from the ground up.

Each dealership enterprise 292 within the automotive dealership management system 288 can comprise a separate dealership (e.g. automotive dealership, trucking dealership, etc.) linked to the active integration enterprise 290 via the Internet/intranet connection 310. In certain applications, for example, the dealership enterprise 292 may comprise a number of separate automotive dealerships demarcated by different corporate boundaries, and/or spanning across multiple buildings or geographic locations.

The dealership enterprise 292 may include number of on-site third-party components (e.g. legacy applications) that can be connected via the integration platform 296 to other applications within the dealership enterprise 292 and with the rest of the automotive dealer management system 288. In the illustrative embodiment of FIG. 13, for example, the dealership enterprise 292 may include a finance and insurance (F & I) application 298 that can be configured to handle various financing and insurance functions for the customer sales process. An on-site database 334 can be further provided at the dealership enterprise level to ensure that the sales process can continue in the event that a communication outage or network bottleneck occurs at one of the other enterprises 290,294. In some embodiments, a local version of the BDC application and the parts and service application can be used in conjunction with the on-site database 334 at the dealership enterprise level to provide continuing service to customers in the event that one of the other enterprises 290,294 is unavailable.

The partnership enterprise 294 may similarly include a number of on-site third-party components that can be connected via the integration platform 296 to other applications within the partner enterprise 294 and with the rest of the automotive dealership management system 288. In the illustrative embodiment of FIG. 13, for example, the partner enterprise 294 may include a separate business system 300 that provides core business functionality for the automotive dealership management system 288, similar to that described above with respect to FIG. 10. The business system may include, for example, an accounting module, a payroll module, a sales force automation (SFA) module, a customer relationship management (CRM) module, and/or an enterprise resource planning (ERP) module.

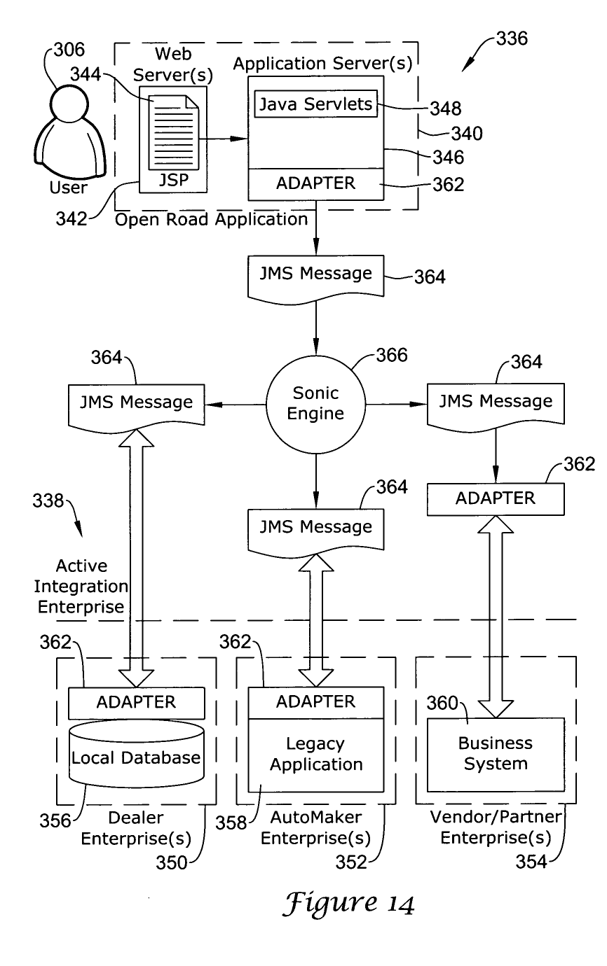

FIG. 14 is a schematic view showing the flow of data through an illustrative automotive dealership management system 336. As can be seen in FIG. 14, an active integration enterprise 338 can be configured to host an open road application, represented generally by the dashed box 340. The open road application 340 can be implemented via one or more web servers 342 operating on a suitable platform 344 such as Java Server Pages (JSP), and can include a number of application servers 346 adapted to support web components using Java Servlets 348 or other suitable framework.

The active integration enterprise 338 can be connected to one or more dealer enterprises 350, automaker enterprises 352, and/or vendor/partner enterprises 354 using a Java Messaging Service (JMS) architecture. The various vertical enterprises 350,352,354 of the automotive dealer management system 336 can each include a number of applications and/or system components that can be connected to the active integration enterprise 338 in a manner similar to that described above. In the illustrative automotive dealership management system 336 depicted in FIG. 14, for example, a local database 356, legacy application 358, and business system 360 can be hosted, respectively, by the dealership enterprise 350, automaker enterprise 352, and vendor/partner enterprise 354. It should be understood, however, that the enterprises 350,352,354 could host other applications and/or system components, as desired.

A number of application adapters 362 (e.g. JCA connectors) can be provided to take application data from a corresponding application or system component, through either an API set or a flat file export, and then transfer it into a corresponding message 364. The application adapters 362 can be configured to handle the integration hooks to the other applications and system components. Typically, one application adapter is used per application, although multiple adapters may be employed depending on the transaction type or other factors.

The message 364 may comprise a system independent, canonical representation of the data a given application has made available to the system 336. The message 364 may include an application area containing information about the type of application, an authentication area that contains sign-on information, message information containing a message subject and any errors, and a data payload area that contains the application data in canonical form. In certain embodiments, the application data may be transformed into XML format in a manner similar to that described above with respect to FIG. 6, using an engine 366.

Once a message 364 is formulated, the message 364 can then be published for access to the other existing applications within the system and/or applications hosted by the active integration enterprise using the integration middleware transport mechanism of the integration platform. In some embodiments, publication of the message 364 can be accomplished via one or more of the web servers 342 and an Internet and/or intranet connection, allowing data to be moved easily into and out of the active integration enterprise 338, as needed.

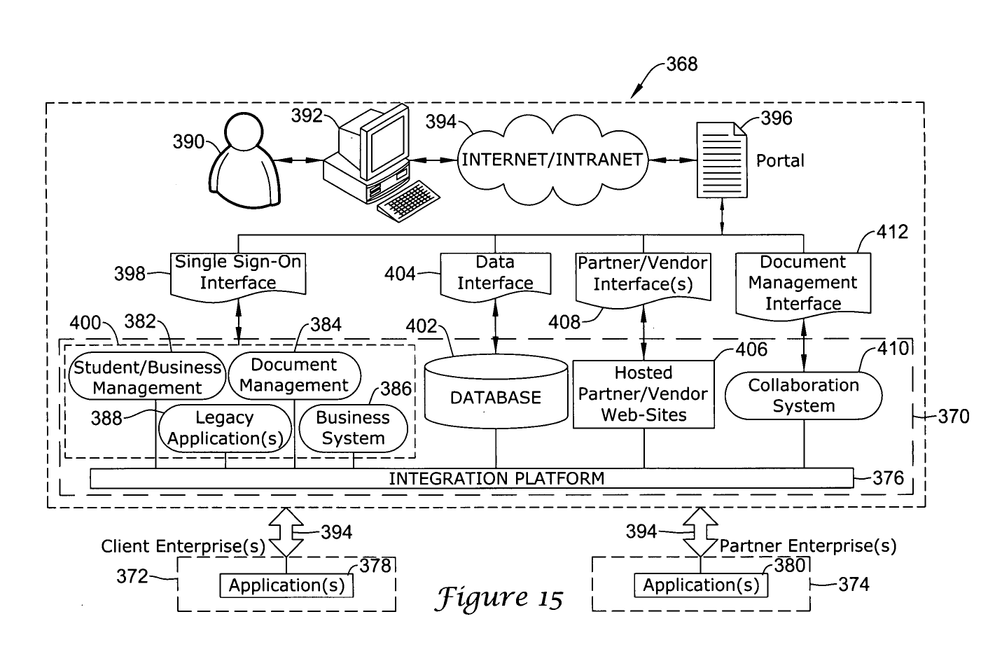

Referring now to FIG. 15, an illustrative educational management system 368 in accordance with an exemplary embodiment of the present invention will now be described. As shown in FIG. 15, the illustrative educational management system 368 may include a web-based active integration enterprise 370 in communication with a number of client enterprises 372 and partner enterprises 374.

The active integration enterprise 370 may include a central integration platform 376, which as described above, can be used to permit one or more client applications 378, one or more partner applications 380, and one or more user-specific applications 382,384,386,388 to be utilized in a distributive fashion and presented as a single view to a user 390 via a personal computer 392 equipped with a web-browser, graphical user interface (GUI), and/or other suitable interface. As with other embodiments herein, the user 390 as well as the one or more client and partner enterprises 372,374 can be connected to the active integration enterprise 370 via the Internet or an intranet connection 394, allowing the user 390 to access the various applications and associated data in real-time and from any location. In some embodiments, the integration platform 376 can be configured to operate on an application integration network (AIN) that provides a transport layer infrastructure and an integration middleware component with client side capability.

The active integration enterprise 370 can host a number of core components that can be utilized to create specific solutions for students, educators, administrators, parents, vendors/suppliers, government officials/agencies, etc. within a school district, college or university, institute, or other educational entity. As shown in FIG. 15, a portal 396 can be configured to manage content received from the integrated applications and present such data as a single view or solution to the user 390 via a single sign-on interface 398. As indicated by dashed lines 400, for example, the single sign-on interface 398 can be configured to provide the user 390 with a single view of several different applications, including a student and business management application 382, a document management application 384, a business system 386, and a number of legacy applications 388. The single sign-on interface 398 can be configured to provide the user 390 a single view of the application data irrespective of whether the application is hosted by the active integration enterprise 370, by a client or partner enterprise 372,374, or by some other third-party client.

A database 402 accessible via a data interface or portlet 404 can be further hosted by the active integration enterprise 370 to provide data storage for each application within the educational management system 368. As with other embodiments herein, the database 402 can be configured to provide each client, application, and market vertical within the system 368 with access to only its data and any user-specific applications 382 and integration service(s) associated with that client, application, or market vertical. In certain embodiments, for example, the database 402 may be responsible for the data storage needs of particular students using a Relational Database Management System (RDMS) that operates on a normalized schema.

The active integration enterprise 370 can be further configured to host a number of partner and/or vendor web sites 406 that can be further presented to the user 390 via a partner/vendor interface or portlet 408. The partner/vendor interface 408 can be configured to provide a means for the user 390 to directly or indirectly interact with one or more of the client and/or partner enterprises 372,374 or other third-party clients. Access to the hosted partner/vendor web sites 406 can be accomplished via the single sign-on interface 398, or through a separate interface from the sign-on interface 398, as desired.

A collaboration system 410 hosted by the active integration enterprise 370 can be configured to provide various document management functions for the educational management system 368. The collaboration system 410 may include a document management application that provides workflow functionality to tailored users, or groups of users, and that permits integration with other document management systems, if desired. In some embodiments, the document management system can be tailored to a specific vertical (e.g. client enterprise 372, partner enterprise 374, etc). The document management system can be accessed via a document management interface or portlet 412, which permits each user 390 of the educational management system 368 to check documents in and out of a central repository, archive documents, and/or back-up documents, as desired. Other functions such as email support, calendaring, scheduling, security, version control, and/or administrative functionality can be further accessed via the document management interface 412, if desired.

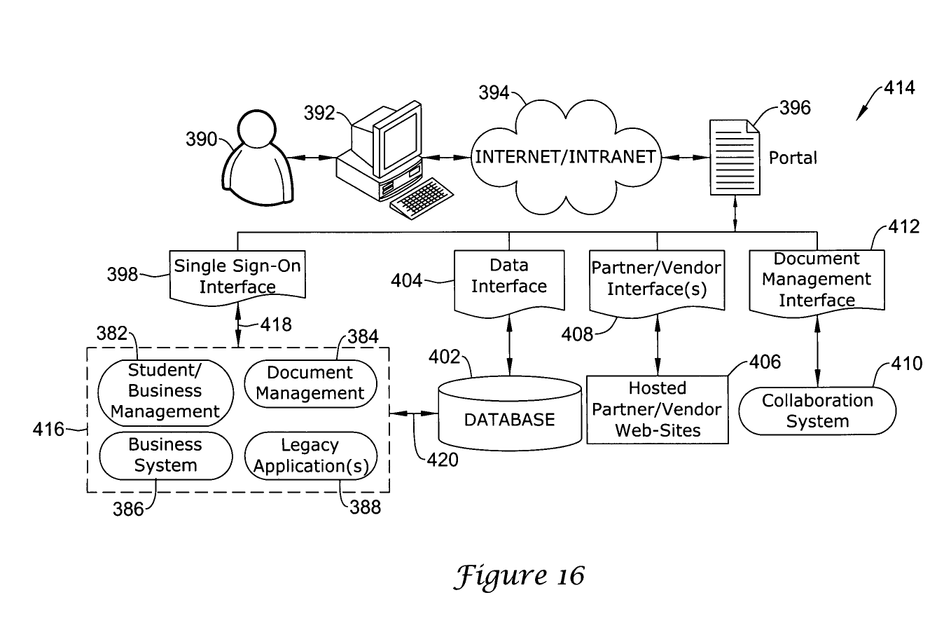

FIG. 16 is a schematic view of an illustrative portal system 414 for use with the educational management system 368 of FIG. 15. In the illustrative embodiment of FIG. 16, the portal system 414 can be configured to permit the user 390 to access one or more hosted and/or third-party applications via the single sign-on interface 398, which as is indicated generally by dashed lines 416 and arrow 418, can be presented as a single view to the user 390 via the single sign-on interface 398 of the portal 396. The applications may include, for example, a custom student and business management application 382, a third-party document management system (DMS) application 384, a business system application 386, and one or more legacy applications 388. In certain embodiments, multiple authentication schemes can be pooled together so that the user 390 does not have to remember a different login and password for each accessed application 382,384,386,388.

As is further indicated generally by arrow 420, each of the applications 382,384,386,388 accessible via the single sign-on interface 398 can be connected to the database 402, allowing for data storage across the educational management system 368. In some embodiments, the single sign-on interface 398 can also be configured to coordinate access to the other applications via the data interface 404, the partner/vendor interface(s) 408, and/or the document management interface 412, if desired. As with other embodiments herein, the portal system 414 can be configured to permit administrators to manage users, groups, and roles through the portal 396 using a suitable interface such as a graphical user interface (GUI).

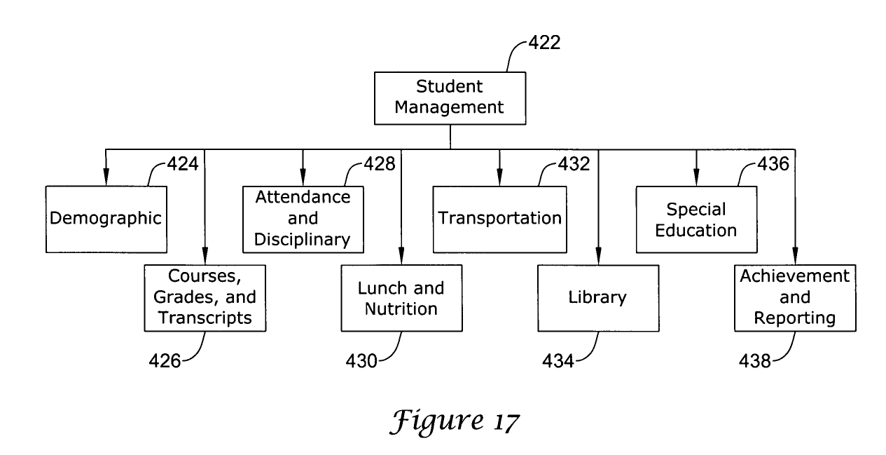

The hosted student and business management application 382 can be configured to handle data in two general categories relating to student management data and business management data. As can be seen in FIG. 17, the student-management side 422 of the educational management system 414 may be further subdivided into a number of sub-categories relating to various demographics, education, and other supporting information relating to each student. These may include for example, student demographic information 424 (e.g. name, address, city, state, etc.); course, grade and transcript information 426; attendance and disciplinary information 428; lunch and nutrition information 430; transportation information (e.g. bus routing); library information 434; special education information 436; and/or achievement and reporting information 438.

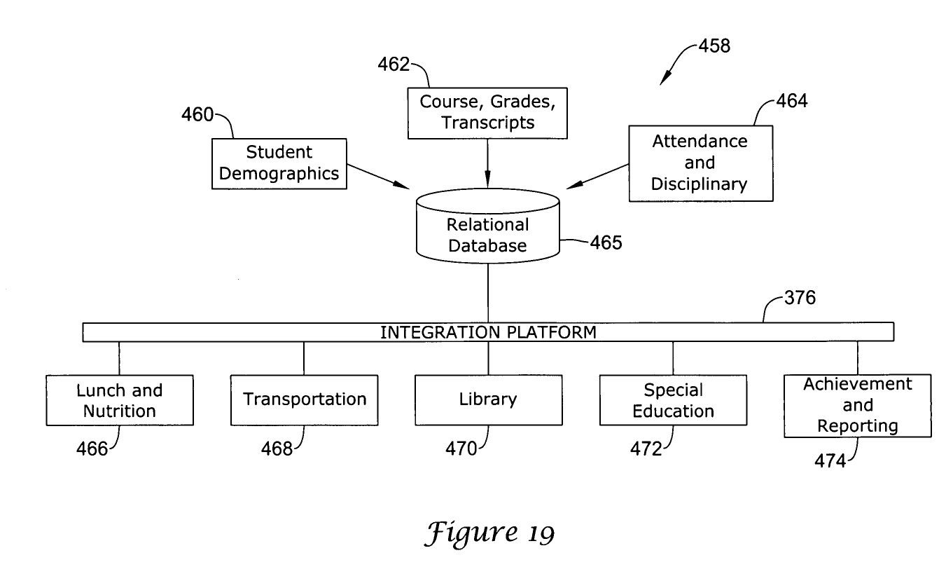

The business management data group may include that data associated with running the school district's day-to-day business operations. As shown in FIG. 19, for example, the business-management side 440 of the educational management system 414 may be further subdivided into a number of sub-categories relating to human resource data, financial data, and vendor/supplier data. These may include for example, demographic information for teachers and other support personnel 442; dates of hire and classification information 444; licensure information 446; payroll information 448; financial information 450 (e.g. general ledger, accounts receivable, accounts payable, etc.); budgeting information 452; purchase and sales order information 454; and/or vendor and supplier information 456.

The student and business management application 382 can be configured to provide the necessary framework to address the specific educational requirements of the educational management system 368, including the management of administrative tasks associated with students as well as other educational specific functionality. In one illustrative educational solution 458 depicted in FIG. 19, for example, the user-specific, hosted components of the educational management system 368 could include a student demographics application module 460, a course, grades and transcripts application module 462, and an attendance and disciplinary application module 464. The application modules 460,462,464 can each be integrated as a normalized student schema using a centralized relational database 465. In use, each hosted application module 460,462,464 can be responsible for a specific student or business related task, supplementing either existing functionality at the client enterprise level, or providing functionality from the ground up, as needed.

A number of other existing (i.e. non-hosted) application modules can be further integrated into the educational management system 458 via the integration platform 376. In some embodiments, and as further shown in FIG. 19, an existing lunch and nutrition application module 466, transportation application module 468, library application module 470, special education application module 472, and/or achievement and reporting application module 474 can be integrated with the hosted application modules 460,462,464 and made part of the educational solution 458, if desired.

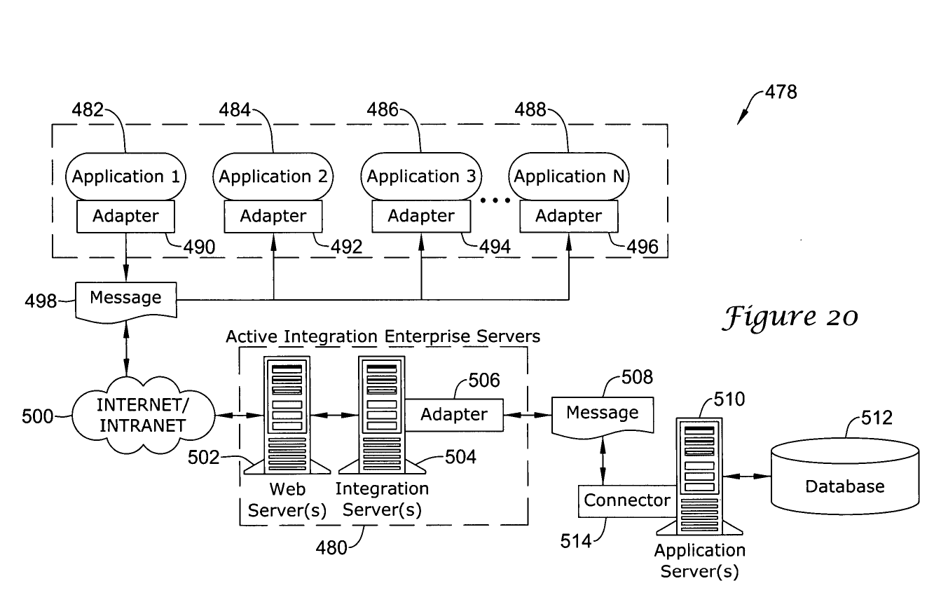

FIG. 20 is a schematic view showing the flow of data through an illustrative educational management system 478. As can be seen in FIG. 20, an active integration enterprise 480 can be configured to host a number of applications 482,484,486,488, each of which can comprise a custom application, legacy application, vendor supplied application, etc., as desired. In certain embodiments, for example, the applications 482,484,486,488 may comprise application modules similar to that described above with respect to FIG. 19, providing various student and/or business data functionality to the educational management system 478.

A number of application adapters 490,492,494,496 (e.g. JCA connectors) can be provided to take application data from a corresponding application or system component, through either an API set or flat file export, and then transfer it into a corresponding message 498. The application adapters 490,492,494,496 may each include a publisher and a subscriber end-point, and can be configured to handle the integration hooks to the other application and system components. Typically, one application adapter is used per application, although multiple adapters may be employed depending on the transaction type or other factors.

The message 498 may comprise a system independent, canonical representation of the data a given application has made available to the system 478. The message 498 may include an application area containing information about the type of application, an authentication area that contains sign-on information, message information containing a message subject and any errors, and a data payload area that contains the application data in canonical form. In certain embodiments, the application data may be transformed into XML format in a manner similar to that described above with respect to FIG. 6.

Once a message 498 is formulated, the message 498 can then be published for access to the other existing applications within the system and/or applications hosted by the active integration enterprise 480 using the integration middleware transport mechanism of the integration platform. In some embodiments, publication of the message 498 can be accomplished via an Internet/intranet connection 500 and one or more web servers 502, allowing data to be moved easily into and out of the active integration enterprise 480.

Once received at the web server 502, the message 498 is then routed to one or more integration servers 504 that include an associated adapter 506 that transforms the data into another message 508 having a format that can understood by the application servers 510 and database 512 via a second connector 508. The integration server 504 further establishes a system-to-system connection to submit data to the database 512, and, if necessary, a business system operating on one or more of the application servers 510. The integration servers 504 take the request from the web servers 502 and call the appropriate backend process (i.e. the middleware component). The applications subscribing to the active integration enterprise 480 may then access the data via the middleware transport mechanism, as needed.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes can be made with respect to various elements described herein without exceeding the scope of the invention.

1. A vertical enterprise system for integrating applications from one or more enterprises into a single interface for a user, the system comprising:
one or more client enterprises;
one or more partner enterprises; and
a web-based active integration enterprise in communication with the one or more client and partner enterprises, the active integration enterprise adapted to host:
a central integration platform operating on an application integration network;
a portal system;
a collaboration system;
a database system; and
one or more user-specific applications.

2. The system of claim 1, wherein the application integration network includes a transport infrastructure and an integration middleware component with client side capability.

3. The system of claim 2, wherein the transport infrastructure comprises the Internet.

4. The system of claim 2, wherein the transport infrastructure comprises an intranet.

5. The system of claim 2, wherein the application integration network includes a web server operatively coupled to a database server and at least one application server.

6. The system of claim 1, wherein the portal system includes a single sign-on interface.

7. The system of claim 6, wherein the portal system is adapted to present data from each enterprise within the vertical enterprise system as a single view to the user.

8. The system of claim 1, wherein the collaboration system includes a document management system.

9. The system of claim 1, wherein the database system includes a relational database management system.

10. The system of claim 1, wherein the active integration enterprise further includes a business system.

11. The system of claim 10, wherein the business system includes a central relational database interconnected with the one or more user-specific applications.

12. The system of claim 10, wherein the business system includes at least one application module from the group consisting of an accounting module, a payroll module, a sales force automation module, a customer relationship module, and an enterprise resource planning module.

13. The system of claim 1, wherein the active integration enterprise is adapted to permit the one or more client and partner enterprises to function in a distributed fashion as a single solution to the user.

14. The system of claim 1, wherein the vertical enterprise system is an automotive dealership management system.

15. The system of claim 14, wherein the one or more user-specific applications includes a business development center (BDC) application module.

16. The system of claim 14, wherein the one or more user-specific applications includes a parts and service application module.

17. The system of claim 1, wherein the vertical enterprise system is an educational management system.

18. The system of claim 17, wherein the one or more user-specific applications includes a student and business management application module.

19. A vertical enterprise system for integrating applications from one or more enterprises into a single interface for a user, the system comprising:
one or more client enterprises;
one or more partner enterprises; and
a web-based active integration enterprise in communication with the one or more client and partner enterprises, the active integration enterprise adapted to host:
a central integration platform operating on an application integration network including a transport infrastructure and an integration middleware component with client side capability;
a portal system including a single sign-on interface adapted to present data from each enterprise within the vertical enterprise system as a single view to the user;
a collaboration system including a document management system;
a database system including a relational database management system; and
one or more user-specific applications.

20. A vertical enterprise system for integrating applications from one or more enterprises into a single interface for a user, the system comprising:
one or more client enterprises;
one or more partner enterprises; and
a web-based active integration enterprise in communication with the one or more client and partner enterprises, the active integration enterprise adapted to host:
a central integration platform operating on an application integration network including a transport infrastructure and an integration middleware component with client side capability;
a portal system including a single sign-on interface adapted to present data from each enterprise within the vertical enterprise system as a single view to the user;
a collaboration system including a document management system;
a database system including a relational database management system;
one or more user-specific applications; and
a business system including a central relational database in communication with the one or more user-specific applications.

21. An automotive dealership management system for integrating applications from one or more clients into a single interface for a user, the system comprising:
a web-based active integration enterprise in communication with the one or more clients, the active integration enterprise adapted to host:
a central integration platform operating on an application integration network;
a portal system;
a collaboration system;
a database system;
a business development center application module; and
a parts and service application module.

22. An educational management system for integrating applications from one or more clients into a single interface for a user, the system comprising:
a web-based active integration enterprise in communication with the one or more clients, the active integration enterprise adapted to host:
a central integration platform operating on an application integration network;
a portal system;
a collaboration system;
a database system; and
a student management application module.

23. A method of integrating applications from one or more client enterprises into a single interface for presentation to a user, the method comprising the steps of:
providing a central integration platform in communication with the one or more client enterprises, the central integration platform including an application integration network adapted to host a portal system, a collaboration system, a database system, and a business system;
hosting one or more user-specific applications on the central integration platform;
providing a single sign-on interface to the user; and
presenting data from the one or more of the user-specific applications and one or more existing client applications as a single view to the user.

24. The method of claim 23, wherein said step of presenting data from one or more user-specific applications and one or more existing client applications is accomplished via the Internet.

25. The method of claim 23, wherein said step of presenting data from one or more user-specific applications and one or more existing client applications is accomplished via an intranet.

26. The method of claim 23, wherein said step of presenting data from the one or more user-specific applications and one or more existing client applications is accomplished using a graphical user interface.

27. The method of claim 23, further comprising the step of storing data from the one or more user-specific applications and existing client applications in a database server.

28. The method of claim 23, wherein the application integration network includes a web server and an integration middleware component with client side capability.

29. The method of claim 28, further comprising the step of transporting data over the application integration network via the web server.

30. The method of claim 29, wherein the movement of data between applications is accomplished using an XML schema.

31. The method of claim 23, wherein said step of hosting one or more user-specific applications on the integration platform is accomplished using one or more application servers.

32. The method of claim 23, further comprising the step of formulating and publishing an application message for integrating data from each user-specific application and each existing client application to the central integration platform.
